(19) United States
(12) Patent Application Publication
(10) Pub. No.: US 2010/0165603 A1
(43) Pub. Date: Jul. 1, 2010

(54) BACKLIGHT MODULE

(75) Inventors: Yu-Ming Sun, Kaohsiung (TW); Chin-Yi Liao, Kaohsiung (TW)

Correspondence Address: LADAS & PARRY LLP, 26 WEST 61ST STREET, NEW YORK, NY, 10023, US

(73) Assignee: ETERNAL CHEMICAL CO., LTD.

(21) Appl. No.: 12/643,395

(22) Filed: Dec. 21, 2009

(30) Foreign Application Priority Data
Dec. 31, 2008 (TW) 097151894

(51) Int. Cl. G02F 1/13357

(52) U.S. Cl. 362/97.2

(57) ABSTRACT

The present invention provides a backlight module, which at least includes: a light guide plate having a plurality of V-cuts on both sides, in which the valley line of the V cut extends as a straight line and the valley lines of the V cuts on the same side of the light guide plate are parallel to each other, while the valley lines of the V cuts on the different sides of the light guide plate are non-parallel to each other; a reflective film disposed on the lower side of the light guide plate; at least a light source disposed around the light guide plate; and a single optical film disposed on the upper side of the light guide plate, in which the optical film includes a substrate and a plurality of light-adjusting structures.

The present invention provides a backlight module combining an optical film having a light-adjusting structure to alter the light field and a double V-cut light guide plate, which can provide highly uniform light and a broad visual angle and thus cure the defects in the conventional double V-cut light guide plate.

### FIELD OF THE INVENTION

The present invention relates to a backlight module apparatus, and more particularly to a backlight module apparatus applied to a liquid crystal display (LCD) and having high brightness, high light uniformity, and broad visual angle.

### DESCRIPTION OF THE PRIOR ART

Generally speaking, the main structure of the LCD includes two main parts: a panel and a backlight module. The panel mainly includes transparent electrode plates, liquid crystals, an alignment layer, a color filter, polarizers, and driving integrated circuits (ICs), and the backlight module, which aims to provide a light source required by the LCD, includes a light source, a light guide plate, and various optical films as its main elements.

On the basis of the location of the light source, backlight modules are classified into direct-type backlight modules and edge-type backlight modules. Generally speaking, the edge-type backlight module is thinner and suitable for notebooks and LCD monitors, while the direct-type module with a greater thickness is suitable for LCD monitors and panel modules of LCD TVs.

As shown in FIG. 1, in order to make the light incident to the display 1 more effectively and be distributed on the display 1 more uniformly, and control the visual angle thereof, optical film plates with different functions are added to the backlight module 12, such as a diffuser film 125, a condensing film 124, and a reflective film 122. However, other problems occur, e.g., because too many films are used, the films themselves cause the absorbing and reflecting phenomena, which thus decreases the utilization rate of the light source, and reduces the brightness thereof. In order to increase the brightness, more lamps can be added to the light source of the backlight module. However, such solution tends to result in not only too much heat accumulated within the LCD, affecting the life span and quality of other elements, but also excessive electricity consumption, and thus cannot meet the requirement of many information appliances whose off-line use relies on batteries.

In order to enhance the brightness and decrease the heat accumulation and energy consumption of the light source, the means most commonly adopted in this field is using an improved optical film in the backlight module to increase the overall brightness, e.g., 3M brightness enhancement film (BEF) condensing film, which achieves the optimal condensing effect by using a top angle of 90°. However, as shown in FIG. 2, light leakage easily occurs with the optical film of this angle when the incident light has a high angle. Besides, such optical film is always expensive to use.

In order to decrease the cost and obtain a backlight module with a high brightness, as shown in FIG. 3, it has been proposed to form V-cuts 321a on a light guide plate 321, so that the light exit angle of the edge light source 123 is guided appropriately via the V-cuts of the light guide plate, thereby achieving the condensing effect. Such light guide plate is also referred to as a V-cut light guide plate. The double V-cut light guide plate is also developed to replace the condensing film in a prism structure. As shown in FIG. 4, by forming two groups of V-cuts 421a and 421b non-parallel to each other on both sides of the light guide plate 421, the light with different exit angles from the light source 123 can be guided appropriately, thereby greatly increasing the brightness of the forward light. However, such structure causes a rather narrow visual angle and non-uniform distribution of light.

### SUMMARY OF THE INVENTION

Accordingly, the present invention is directed to a backlight module apparatus combining an optical film having a light-adjusting structure to alter the light field and a double V-cut light guide plate, which can provide highly uniform light and a broad visual angle, thereby curing the defects of the conventional double V-cut light guide plate.

In another aspect, the present invention is directed to a multifunctional film with a variety of optical characteristics, which can provide uniform light distribution and a large visual angle, reduce light leakage, and decrease the thickness of the panel since fewer films are needed.

In order to achieve the above and other objectives, the present invention provides a backlight module, which comprises:

A light guide plate, having a plurality of V-cuts on both sides;

A reflective film, disposed on a lower side of the light guide plate; and

At least one light source, disposed around the light guide plate.

The backlight module is characterized in including a single optical film disposed on an upper side of the light guide plate, and the light field of the backlight module meets the following conditions (I), (II) and (III):

Horizontal half brightness visual angle≧70° (I)

Brightness uniformity≧70% (II)

Light leakage rate at large visual angle≦65% (III).

### BRIEF DESCRIPTION OF THE DRAWINGS

FIG. 1 is a simple schematic view of a backlight module in prior art.

FIG. 2 is a simple schematic view of a condensing film in prior art.

FIG. 3 is a simple schematic view of a light guide plate in prior art.

FIG. 4 is a simple schematic view of a light guide plate in prior art.

FIG. 5 is a schematic view of an arc-shaped cylindrical microstructure of an optical film of a backlight module according to the present invention.

FIGS. 6a and 6b are schematic views of an embodiment of a backlight module according to the present invention.

FIGS. 7a and 7b are schematic views of an embodiment of the backlight module according to the present invention.

FIG. 7c is a coordinate diagram of the relative brightness intensity corresponding to different horizontal visual angles of an optical film of the backlight module according to the present invention.

FIG. 8 is a schematic view of an embodiment of the backlight module according to the present invention.

FIGS. 9a and 9b are schematic views of an embodiment of the backlight module according to the present invention.

FIGS. 10a and 10b are schematic views of an embodiment of the backlight module according to the present invention.

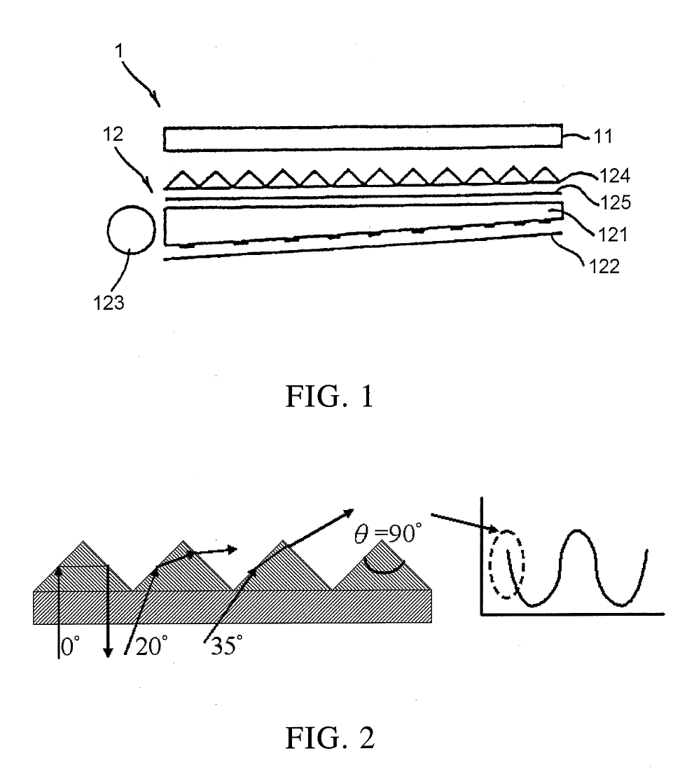

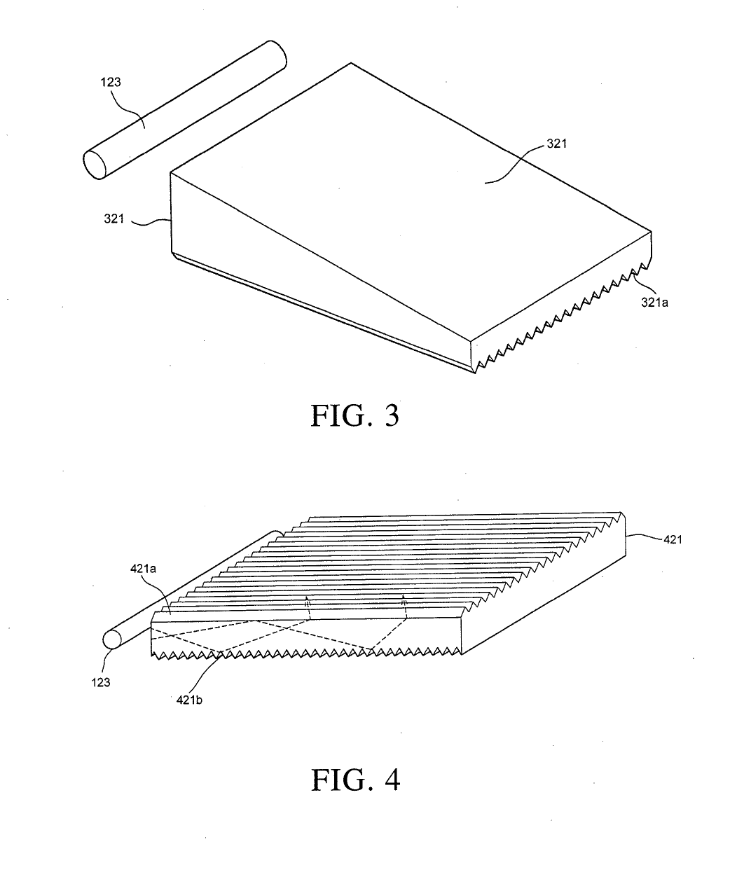

### DETAILED DESCRIPTION

The terms used herein are only intended to describe the implementation aspects, not to limit the scope of the present invention. For example, the terms “a” and “an” used in the specification covers both singular and plural forms unless it is otherwise specified.

The “double V-cut light guide plate” herein refers to a light guide plate having a plurality of V-cut structures on both sides, in which the valley line of the V cut extends as a straight line. Preferably, the valley lines of the V cuts on the same side of the light guide plate are parallel to each other, while the valley lines of the V cuts on different sides of the light guide plate are non-parallel to each other.

The “prism cylindrical microstructure” herein is constituted by two inclined surfaces which may be curved surfaces or planes; the two inclined surfaces intersect at the top of the prism to form a peak, and each inclined surface intersects an inclined surface of another neighboring cylindrical microstructure at the bottom to form a valley.

The “arc-shaped cylindrical microstructure” herein is constituted by two inclined planes. The intersection point on the top of the two inclined planes is passivated to form a curved surface, and each of the two inclined plates intersects an inclined surface of another neighboring cylindrical microstructure to from a valley.

The “linear cylindrical microstructure” herein is defined as a cylindrical microstructure with ridges extending as straight lines.

The “serpentine cylindrical microstructure” herein is defined as a cylindrical microstructure with ridges extending as curved configurations. The ridges extending as curved configurations generate a proper surface curvature variation of 0.2% to 100%, preferably 1% to 20%, of the height of the serpentine cylindrical microstructure.

The present invention provides a backlight module, which comprises:

A light guide plate, having a plurality of V cuts on both sides;

A reflective film, disposed on a lower side of the light guide plate; and

At least one light source, disposed around the light guide plate.

The backlight module is characterized in including a single optical film disposed on an upper side of the light guide plate, and a light field of the backlight module meets the following conditions (I), (II), and (III).

Horizontal half brightness visual angle≧70° (I)

Brightness uniformity≧70% (II)

Light leakage rate at large visual angle≦65% (III).

The optical film used by the backlight module of the present invention includes a substrate and a plurality of light-adjusting structures disposed on a side surface of the substrate. The substrate used by the optical film of the present invention includes a support layer, and the support layer may be of a material well known to those of ordinary skill in the art, such as glass or plastic. The plastic may be selected from a group consisting of (but not limited to) polyester resin such as polyethylene terephthalate (PET) or polyethylene naphthalate (PEN), polyacrylate resin such as polymethyl methacrylate (PMMA), polyolefin resin such as polyethylene (PE) or polypropylene (PP), polycycloolefin resin, polyimide resin, polycarbonate resin, polyurethane resin, triacetyl cellulose (TAC), polylactic acid, and any combination thereof. Preferably, the plastic is selected from a group consisting of polyester resin, polycarbonate resin, and any combination thereof, and more preferably, the plastic is PET. The thickness of the substrate usually depends on the requirements of the optical product to be manufactured, and is commonly 15 μm to 300 μm.

In order to eliminate the optical rainbow grain, the substrate may optionally include a plurality of transparent beads. The types of the transparent beads are well known to persons skilled in the art, and include (but are not limited to) glass beads, metal oxide beads, plastic beads, or any mixture thereof. The types of the plastic beads are not particularly restricted, and include (but are not limited to) acrylic resin, styrene resin, urethane resin, silicone resin, or any mixture thereof, among which acrylic resin or silicone resin are preferred. The transparent beads generally have a diameter of 1 μm to 10 μm.

In order to increase the brightness of the backlight module, the substrate may optionally include a reflective polarizer layer. The “reflective polarizer layer” is well known to those of ordinary skill in the art, and is generally classified into two types: one type of the reflective polarizer layer splits the light into two parts by means of rotary polarization through coating or laminating the cholesteric liquid crystal (LC) and ¼λ film (quarter wave film), so as to permit the right rotation light to pass through and reflect the left rotation light and convert it into the usable right rotation light via a converting mechanism; the other type is formed by stacking a plurality of polymer films with special birefringence characteristics. The reflective polarizer layer reflects the polarized light in the non-transmission direction back to the backlight module effectively. Since the reflective film in the module has diffusion and scrambling effects, the polarized light in the original non-transmission direction may be partially converted into the polarized light in the transmission direction, and after repeated motions of the reflective film, most of the light that originally should be absorbed and consumed are converted into the usable effective light, so the brightness is greatly increased.

The light-adjusting structures used by the optical film of the present invention aim to eliminate the non-uniform light output and narrow visual angle of the light guide plate with a plurality of V-cuts on both sides and reduce that the light leakage that easily occurs with the conventional optical film when the incident light has a high angle. The light-adjusting structures used by the optical film of the present invention may be well known to those of ordinary skill in the art of the present invention, and any structure with the above functions falls within the scope of the present invention, for example, but not limited to, cylindrical microstructure, conical microstructure, solid-angle microstructure, orange-peel-shaped microstructure, capsule-shaped microstructure, concave-convex microstructure, micro lens structure or any combination thereof, among which the cylindrical microstructure, concave-convex microstructure, or micro lens structure is preferred.

The ridges of the cylindrical microstructures may be linear, serpentine, zigzag, or any combination thereof, and preferably linear. The ridges of the two neighboring cylindrical microstructures may be parallel or non-parallel to each other. The peak height of the cylindrical microstructures may or may not vary along an extending direction (i.e., ridge direction). The peak height of the cylindrical microstructures varying along the extending direction means that the height of at least one part of the locations of the cylindrical microstructures varies randomly or regularly as the location of the main shaft varies, in which the peak height varies for at least 3%, and preferably, between 5% and 50% of the nominal height (or average height).

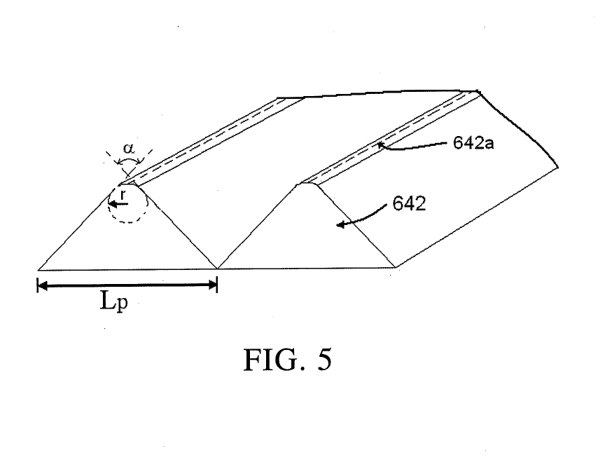

The width of the cylindrical microstructures used in the present invention is not particularly limited, and is in the range of 1 μm to 100 μm as well known to those of ordinary skill in the art. Preferably, the width is in the range of 20 μm to 70 μm. The above cylindrical microstructures may be prism cylindrical microstructures, arc-shaped cylindrical microstructures, or any mixture thereof, and arc-shaped cylindrical microstructures are preferred. According to the present invention, as shown in FIG. 5, when the cylindrical microstructures are arc-shaped cylindrical microstructures, the width of the cylindrical microstructures 642 of the optical film refers to a distance between two valleys of the microstructures (marked as Lp in FIG. 5). The top angle curvature radius (marked as r in FIG. 5) is not particularly limited, and is less than 10 μm, preferably about less than 5 μm, and more preferably between 1 μm and 4 μm as well known to those of ordinary skill in the art. The top angle (marked as α in FIG. 5) of the light adjusting structures is between 95° and 130°, preferably between 100° and 120°.

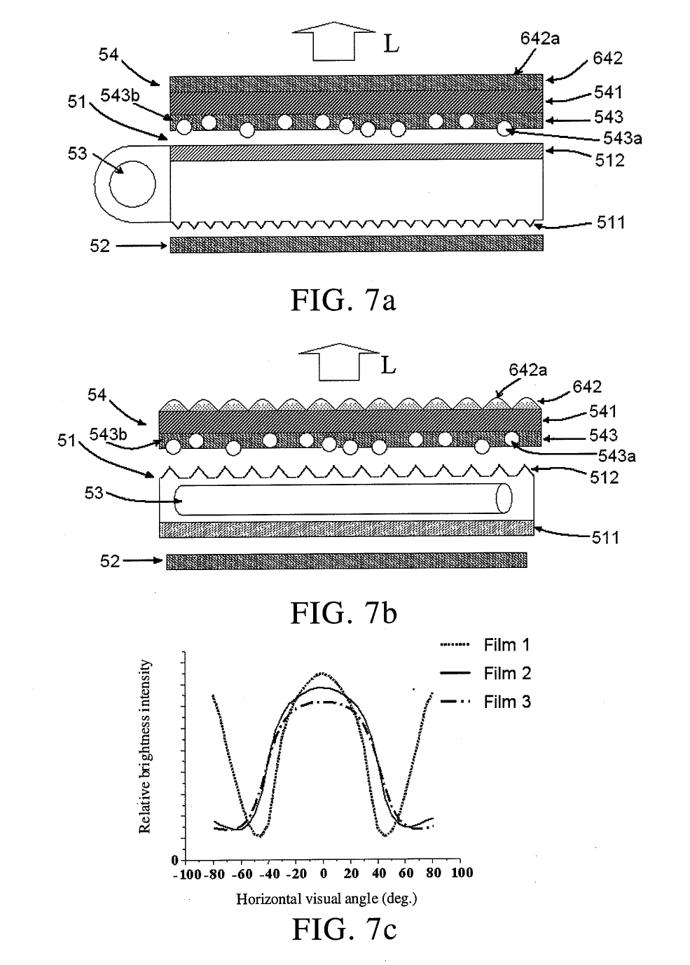

The ridge of the cylindrical microstructure 642 refers to a line connected by the highest points of the microstructure (marked as 642a in FIG. 5), which is non-parallel to the lamp positioning direction, thereby improving the non-uniform distribution of the light field of the exit light caused by the lamp and the V-cuts of the light guide plate. Preferably, the ridge 642a of the cylindrical microstructure 642 is perpendicular to the positioning direction of the lamp 53 (see FIG. 7).

The cylindrical microstructure 642 of the optical film with a height of 5 μm-100 μm may be formed by any resin with a refractive index greater than that of the air. Generally speaking, the higher the refractive index, the better the effect. The optical film of the present invention has a refractive index of at least 1.49, preferably 1.49 to 1.65.

The cylindrical microstructure 642 of the optical film may be prepared by any method well known to those of ordinary skill in the art, e.g., the cylindrical microstructure 642 of the optical film may be prepared by embossing, by directly applying a coating on the surface of the substrate to form a plurality of microstructures, or by applying a coating on the substrate and then carving the desired microstructures on the coating. The coating process includes, but is not limited to, slot coating, micro gravure coating, or roller coating, and the preparation process is realized on the substrate through a roll to roll continuous manufacturing technique. The preferred process is directly coating a plurality of cylindrical microstructures on the surface of the substrate.

The coating for forming the cylindrical microstructures is formed by curing the coating material, in which the coating material includes at least a resin selected from a group consisting of UV-cured resin, thermosetting resin, thermoplastic resin, and a mixture thereof, and the UV-cured resin is preferred.

An example of the UV-cured resin suitable for the present invention is acrylic resin. The acrylic resin includes, but is not limited to, (meth)acrylate resin, urethane acrylate resin, polyester acrylate resin, epoxy acrylate resin, or a mixture thereof, and the (meth)acrylate resin is preferred.

The acrylic resin used to prepare the cylindrical microstructures described above includes monomer, photoinitiator, and crosslinking agent. Suitable examples of polymonomer include epoxy diacrylate, halogenated epoxy diacrylate, methyl methacrylate, isobornyl acrylate, 2-phenoxy ethyl acrylate, acrylamide, styrene, halogenated styrene, acrylic acid, (meth)acrylonitrile, fluorene derivative diacrylate monomer, biphenylepoxyethyl acrylate, halogenated biphenylepoxyethyl acrylate, alkoxylated epoxy diacrylate, halogenated alkoxylated epoxy diacrylate, aliphatic urethane diacrylate, aliphatic urethane hexaacrylate, aromatic urethane hexaacrylate, bisphenol-A epoxy diacrylate, novolac epoxy acrylate, polyester acrylate, polyester diacrylate, acrylate-capped urethane oligomer, or any mixture thereof. Preferred polymonomer includes halogenated epoxy diacrylate, methyl methacrylate, 2-phenoxy ethyl acrylate, aliphatic urethane diacrylate, aliphatic urethane hexaacrylate, and aromatic urethane hexaacrylate.

The photoinitiator suitable for the present invention is not particularly limited, and may be selected from a group consisting of, for example, benzophenone, benzoin, benzil, 2,2-dimethoxy-1,2-diphenylethan-1-one, 1-hydroxy cyclohexyl phenyl ketone, 2,4,6-trimethylbenzoyl diphenyl phosphine oxide (TPO), and any combination thereof, and benzophenone is preferred.

The suitable crosslinking agent may be monomer or oligomer, e.g., (meth)acrylate having one or more functional groups, preferably one having a plurality of functional groups, so as to increase the glass transition temperature. The types of acrylate described above are well known to those of ordinary skill in the art, and include, but are not limited to, (meth)acrylate; urethane acrylate, such as aliphatic urethane acrylate, aliphatic urethane hexaacrylate, or aromatic urethane hexaacrylate; polyester acrylate, such as polyester diacrylate; epoxy acrylate, such as bisphenol-A epoxy diacrylate; novolac epoxy acrylate, or any mixture thereof. The (meth)acrylate may have two or more functional groups, preferably a plurality of functional groups. Examples of (meth)acrylate suitable for the present invention include, but are not limited to, tripropylene glycol di(meth)acrylate, 1,4-butanediol di(meth)acrylate, 1,6-hexanediol di(meth)acrylate, polyethyleneglycol di(meth)acrylate, allylated cyclohexyl di(meth)acrylate, isocyanurate di(meth)acrylate, ethoxylated trimethylol propane tri(meth)acrylate, propoxylated glycerol tri(meth)acrylate, trimethylol propane tri(meth)acrylate, tris(acryloxyethyl)isocyanurate, or any mixture thereof. The commercially available acrylate suitable for the present invention includes: SR454®, SR494®, SR9020®, SR9021®, or SR9041® manufactured by Sartomer Company; 624-100® manufactured by Eternal Chemical Company; and Ebecryl 600®, Ebecryl 830®, Ebecryl 3605®, or Ebecryl 6700® manufactured by UCB.

Furthermore, any conventional additive may be optionally added to the coating material in the present invention, so as to change the physical or chemical performance thereof. The additives suitable for the present invention are generally selected from a group consisting of inorganic filler, anti-static agent, leveling agent, antifoaming agent, and any combination thereof. For example, in order to increase the hardness of the cured resin, an inorganic filler may be optionally added to the resin to prevent the optical properties from being affected by the slumping phenomenon of the condenser structure. Inorganic fillers can also improve the brightness of the LCD panel. The inorganic fillers that can be used for the present invention are well known to those of ordinary skill in the art of the present invention, and include, but are not limited to, zinc oxide (ZnO), silicon dioxide (SiO₂), strontium titanate, zirconia (ZrO₂), aluminium oxide (Al₂O₃), calcium carbonate, titanium dioxide (TiO₂), calcium sulfate, barium sulfate, or any mixture thereof, among which TiO₂, ZrO₂, SiO₂, ZnO, or any mixture thereof are preferred. The inorganic fillers have a particle size of about 10 nm to about 350 nm, and preferably 50 nm to 150 nm.

The concave-convex microstructures serving as the light-adjusting structures in the present invention may be prepared integrally with the substrate by, for instance, embossing or injection, or may be alternatively prepared through machining on the substrate in a conventional manner, e.g., applying a coating containing transparent beads on the surface of the substrate to form a coating having concave-convex microstructures, or applying a coating on the substrate and then carving the required concave-convex microstructures on the coating. The thickness of the concave-convex microstructure layer, which is relevant to the size of the concave-convex microstructures, is not particularly limited and is generally between about 2 μm and about 20 μm, and preferably between about 5 μm and about 10 μm.

According to a preferred embodiment of the present invention, the concave-convex microstructures are formed by applying a coating containing transparent beads and a binder on the surface of the substrate through the roll to roll continuous manufacturing technique.

The shape of the transparent beads used for the present invention is not particularly limited and includes sphere, rhombus, ellipse, rice-granule, biconvex-lens, among which sphere is preferred. Additionally, the types of the beads are not particularly limited and may be glass beads, metal oxide beads, plastic beads, or any mixture thereof. The types of the plastic beads are not particularly limited, and include, but are not limited to, acrylic resin, styrene resin, urethane resin, silicone resin, or any mixture thereof, among which acrylic resin or silicone resin are preferred. The types of the metal oxide beads are not particularly limited either, and include, but are not limited to, TiO₂, SiO₂, ZnO, Al₂O₃, ZrO₂, or any mixture thereof. The beads used in the present invention have an average particle size of between about 1 μm and about 25 μm, preferably between about 1 μm and about 15 μm, and more preferably between about 1 μm and about 10 μm, and the refractive index of the beads is 1.3 to 2.5, and preferably 1.4 to 1.55. In order to achieve a desirable diffusion effect and eliminate the rainbow grain, the absolute value of the difference between the refractive index of the beads in the coating and that of the structured surface needs to fall between 0.05 and 0.2.

The types of the binder used in the present invention are not particularly limited, and are well known to those of ordinary skill in the art of the present invention, which are selected from, but are not limited to, a group consisting of acrylic resin, polyamide resin, epoxy resin, fluorocarbon resin, polyimide resin, polyurethane resin, alkyd resin, polyester resin, and any mixture thereof, and preferably, acrylic resin, polyurethane resin, polyester resin, or any mixture thereof are used. The binder used in the present invention is preferably colorless and transparent, since the binder has to allow the light to transmit through it. The concave-convex microstructures formed by the beads of the present invention are not particularly limited, but preferably the beards are uniformly distributed in a single layer, which can reduce not only the material cost, but also the waste of the light source, thereby increasing the brightness of the composite optical film. The content of the beads relative to the solid content of the binder is about 0.1 parts by weight to about 28 parts by weight of beads in each 100 parts by weight of the solid content of the binder.

The micro lens structures used as light-adjusting structures in the present invention may be formed on the surface of the substrate in any conventional manner, e.g., embossing or injection, and preferably embossing.

According to an embodiment of the present invention, the substrate includes a support layer and a reflective polarizer layer, and the light-adjusting structures are preferably concave-convex microstructures or micro lens structures.

According to another embodiment of the present invention, the substrate includes a support layer, and the light-adjusting structures are preferably linear arc-shaped cylindrical microstructures.

In order to protect the surface of the substrate from being scratched, thereby affecting the optical characteristics of the film, an anti-scratch layer may be optionally formed on the other surface of the substrate opposite the light-adjusting structures. The anti-scratch layer may be smooth or non-smooth and may be formed in any conventional manner, including, but not limited to, screen printing, spraying, embossing, or applying a coating containing transparent beads and a binder on the surface of the substrate. The anti-scratch layer containing transparent beads enables the anti-scratch layer to have a light diffusion effect to a certain extent. The definitions of the transparent beads and the binder have been given above. Additionally, the thickness of the anti-scratch layer is preferably between 0.5 μm and 30 μm, and more preferably between 1 μm and 10 μm.

The transparent beads contained in the anti-scratch layer of the present invention have a light diffusion function. When the light-adjusting structure layer does not exist on the upper surface of the substrate, the haze of the optical film is 20%-95%, and preferably 30%-60%, as measured according to the JIS K7136 standard. Additionally, the anti-scratch layer of the present invention has the pencil hardness of up to 3H or even higher as measured according to the JIS K5400 standard.

The light guide plate with a plurality of V-cuts on both sides in the backlight module of the present invention is not particularly limited, and is well known to those of ordinary skill in the art. The valley line of the V-cut extends as a straight line, and preferably, the valley lines of the V-cuts on the same side of the light guide plate are parallel to each other, while the valley lines of the V-cuts on different sides of the light guide plate are non-parallel to each other. More preferably, the valley lines of the V-cuts on the different sides of the light guide plate are perpendicular to each other. Additionally, the depth and sparse-dense distribution of the V-cuts can be adjusted according to the design of the backlight module, and two adjacent V-cuts on the same side of the light guide plate may be located close to each other or spaced apart by a flat surface between them. Additionally, the valley of the V-cut may also be a flat surface, depending on the design of the backlight module.

The light source used in the backlight module of the present invention is not particularly limited, and is well known to those of ordinary skill in the art. The number of the light sources may be increased or decreased according to actual requirements, and each light source may be the same or different, and may be selected from (but are not limited to) a group consisting of cold cathode fluorescent lamp (CCFL), light emitting diode (LED), organic light emitting diode (OLED), polymer light emitting diode (PLED), external electrode fluorescent lamp (EEFL), flat fluorescent lamp (FFL), carbon nanotube field emission light emitting element, halogen lamp, xenon lamp, or high-pressure mercury lamp. The light source is preferably CCFL, and preferably, one or more lamps are disposed at any position around the light guide plate according to the actual requirements.

The reflective film of the backlight module of the present invention is not particularly limited, and is well known to those of ordinary skill in the art. An anti-UV high diffusion reflective film is preferably used, and as according to the ASTM D523 standard, when the light is projected at an incident angle of 60°, the measured glossiness is less than 10%, and a reflectivity of more than 95% can be provided in the visible light wavelength range of 380 nm to 780 nm.

The structure of the backlight module of the present invention is demonstrated below with reference to the drawings, which is not intended to limit the scope of the present invention. Any modification and variation easily achieved by those of ordinary skill in the art are included in the disclosure of the present invention.

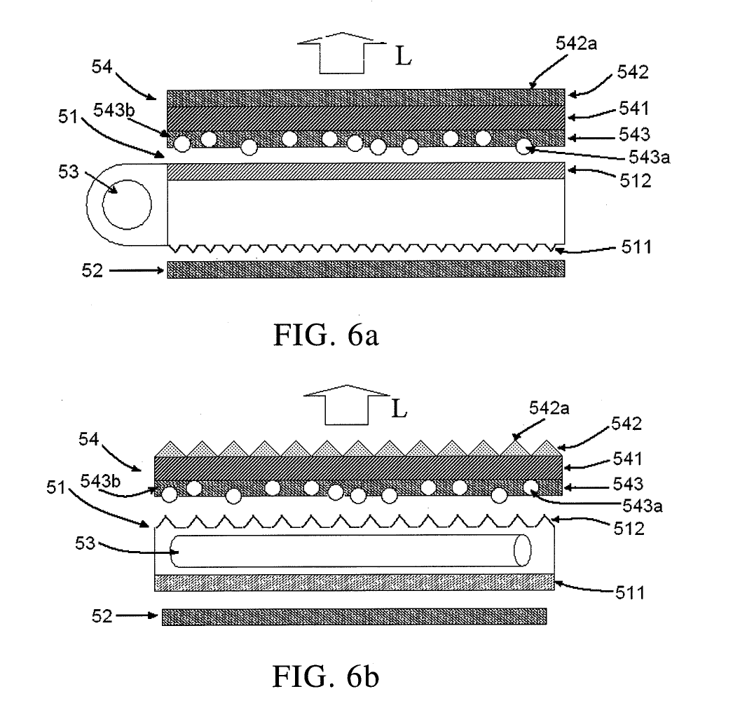

FIGS. 6a and 6b (sectional views horizontally rotated by 90°) show a preferred embodiment of the backlight module of the present invention. The backlight module includes: a light guide plate 51, having a plurality of V-cuts on both sides, that is, a first V-cut group 511 and a second V-cut group 512, in which the valley lines of the V-cuts on the same side of the light guide plate are parallel to each other, while the valley lines of the V-cuts on different sides of the light guide plate are perpendicular to each other; a reflective film 52, disposed outside one side of the light guide plate; a lamp 53, disposed on one side of the light guide plate, in which the lamp positioning direction thereof is parallel to the ridges of the V-cut group on one side of the light guide plate and perpendicular to the ridges of the V-cut group on the other side of the light guide plate; and an optical film 54, disposed outside the other side of the light guide plate opposite to the reflective film The optical film includes a support layer 541, and the light-adjusting structures on one side of the support layer have a plurality of prism cylindrical microstructures 542, in which the ridges 542a of the cylindrical microstructures and the lamp positioning direction are non-parallel to each other, preferably perpendicular to each other. The other side surface of the support layer 541 opposite to the prism cylindrical microstructures has an anti-scratch layer 543, and the anti-scratch layer includes a binder 543b and a plurality of transparent beads 543a.

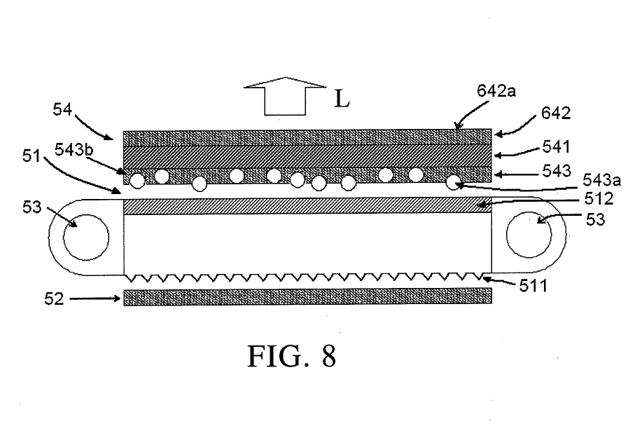

FIGS. 7a and 7b (sectional views horizontally rotated by 90°) and FIG. 8 show another preferred embodiment of the backlight module of the present invention. The backlight module includes: a light guide plate 51, having a plurality of V-cuts on both sides, that is, a first V-cut group 511 and a second V-cut group 512 respectively, in which the valley lines of the V-cuts on the same side of the light guide plate are parallel to each other, while the valley lines of the V-cuts on different sides of the light guide plate are perpendicular to each other; a reflective film 52, disposed outside one side of the light guide plate; a lamp (marked as 53 in FIGS. 7a and 7b), disposed on one side of the light guide plate or two lamps (marked as 53 in FIG. 8) disposed on two sides of the light guide plate, in which the lamp positioning direction thereof is parallel to the ridges of the V-cut group on one side of the light guide plate and perpendicular to the ridges of the V-cut group on the other side of the light guide plate; and an optical film 54, disposed outside the other side of the light guide plate opposite to the reflective film. The optical film includes a support layer 541, and the light-adjusting structures on one side of the support layer have a plurality of arc-shaped cylindrical microstructures 642, in which the ridges 642a of the cylindrical structures and the lamp positioning direction are non-parallel to each other, preferably perpendicular to each other. The other side surface of the support layer 542 opposite the cylindrical microstructures has an anti-scratch layer 543, and the anti-scratch layer includes a binder 543b and a plurality of transparent beads 543a.

Compared with the conventional optical film, the optical film in the above embodiment can significantly improve the light leakage phenomenon. As shown in FIG. 7c, the optical film 1 (Film 1) is a commercially available condensing film with a top angle of 90°, and the optical film 2 (Film 2) and the optical film 3 (Film 3) are optical films of the above embodiment. The top angle of the optical film 2 is 103°, and the curvature radius r of the optical film 2 is 2 μm, while the top angle of the optical film 3 is 115°, and the curvature radius r of the optical film 3 is 2 μm. The optical film 1 has the highest brightness value at the front visual angle, but the brightness of the optical film decreases dramatically at an inclined visual angle, which indicates that the visual angle thereof is excessively narrow, and the user can see the obvious difference in the brightness of the display when he/she slightly inclines the visual angle by certain degrees. The optical film 2 and the optical film 3 have desirable brightness uniformity at the front visual angle and different visual angles, and do not have this problem. Additionally, when the display is in use, the part with a high visual angle has no value. Thus, with regard to the brightness value of this part, the lower the better. In this way, the light at this part may be transferred to the part with a lower visual angle, so that the light source can be more effectively utilized. However, the optical film 1 has higher brightness value at a high visual angle, which indicates that it has serious light leakage phenomenon, while the optical film 2 and the optical film 3 do not have this problem.

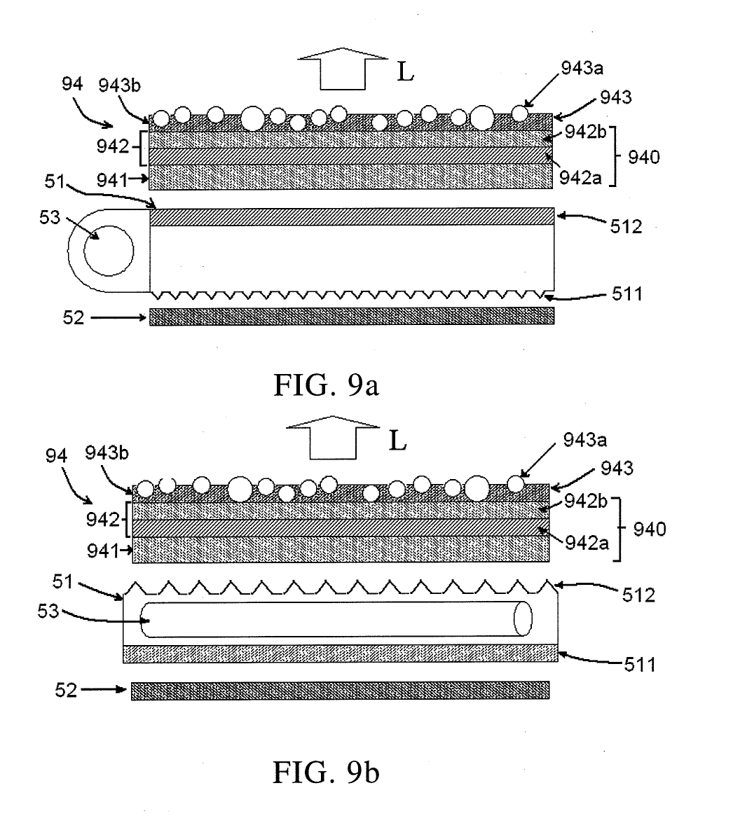

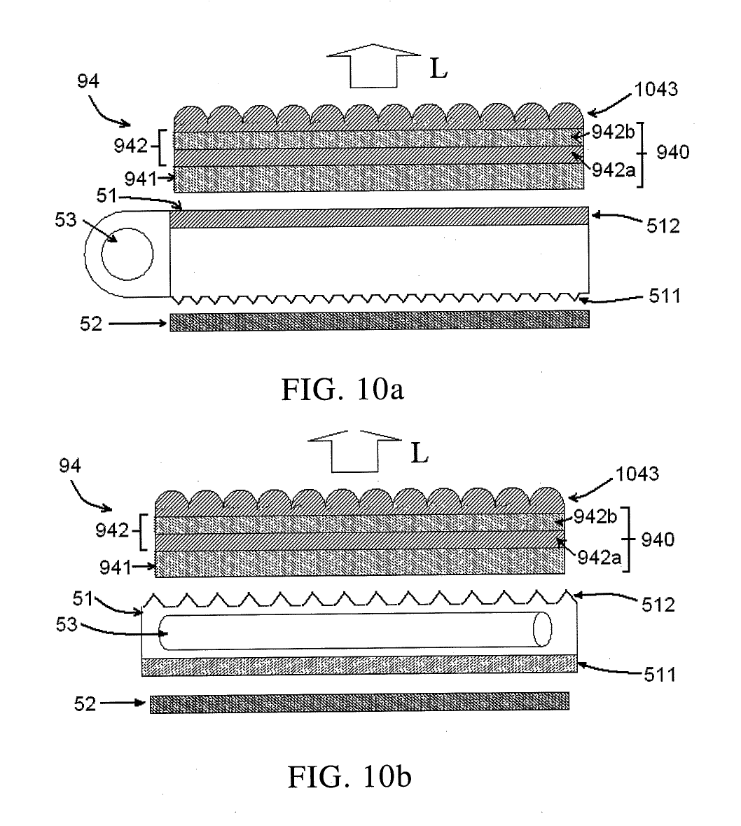

FIGS. 9a, 9b and FIGS. 10a and 10b (sectional views rotated horizontally by 90°) show another embodiment of the backlight module of the present invention. According to the embodiment of FIGS. 9a and 9b, the backlight module includes: a light guide plate 51, having a plurality of V-cuts on both sides, that is, a first V-cut group 511 and a second V-cut group 512, in which the valley lines of the V-cuts on the same side of the light guide plate are parallel to each other, while the valley lines of the V-cuts on different sides of the light guide plate are perpendicular to each other; a reflective film 52, disposed outside one side of the light guide plate; a lamp 53, disposed on one side of the light guide plate, and the positioning direction thereof is parallel to the ridges of the V-cut group on one side of the light guide plate and perpendicular to the ridges of the V-cut group on the other side of the light guide plate; and an optical film 94, disposed outside the other side of the light guide plate opposite to the reflective film. The optical film includes a substrate 940 and light-adjusting structures disposed on one side of the substrate. The substrate includes a support layer 941 and a reflective polarizer layer 942. The light-adjusting structure is a coating having concave-convex microstructures (marked as 943 in FIG. 9), and the coating of the concave-convex microstructures includes a binder 943b and a plurality of transparent beads 943a. The reflective polarizer layer includes a cholesterol liquid crystal layer 942a and a ¼λ film 942b. In the embodiment of FIGS. 10a and 10b, the substrate 940 includes a support layer 941 and a reflective polarizer layer 942. The light-adjusting structure is a coating having micro lens structures (marked as 1043 in FIG. 10), and the reflective polarizer layer includes a cholesterol liquid crystal layer 942a and a ¼λ film 942b.

The backlight module of the present invention has a light guide plate with V-cuts on both sides thereof and the ridges of the V-cuts are non-parallel to each other, which can appropriately guide the light output from the side light sources at different angles, thereby greatly increasing the brightness value of the forward light. In addition, as only one optical film is used in the present invention, it saves the cost and decreases the thickness of the backlight module, and furthermore, the optical film has various optical characteristics which help uniformly distribute the light and decrease the light leakage effect at a large visual angle. Therefore, the backlight module of the present invention has high brightness, high light uniformity, and broad visual angle.

The present invention is further illustrated by the following embodiments, which are not intended to limit the scope of the present invention. It will be apparent to those skilled in the art that various modifications and variations can be made to the structure of the present invention without departing from the scope or spirit of the present invention.

### Embodiment 1

A plurality of prism cylindrical microstructures (acrylic resin) with a top angle of 95° and a width of the cylindrical microstructure of 50 μm is formed on a surface of a PET support layer including an anti-scratch layer and having a haze of 35%, to form an optical film.

### Embodiment 2

A plurality of prism cylindrical microstructures (acrylic resin) with a top angle of 103° and a width of the cylindrical microstructure of 50 μm is formed on a surface of a PET support layer including an anti-scratch layer and having a haze of 27%, to form an optical film.

### Embodiment 3

A plurality of prism cylindrical microstructures (acrylic resin) with a top angle of 103° and a width of the cylindrical microstructure of 50 μm is formed on a surface of a PET support layer including an anti-scratch layer and having a haze of 55%, to form an optical film.

### Embodiment 4

A plurality of prism cylindrical microstructures (acrylic resin) with a top angle of 103° and a width of the cylindrical microstructure of 50 μm is formed on a surface of a PET support layer including an anti-scratch layer and having a haze of 95%, to form an optical film.

### Embodiment 5

A plurality of prism cylindrical microstructures (acrylic resin) with a top angle of 108° and a width of the cylindrical microstructure of 50 μm is formed on a surface of a PET support layer including an anti-scratch layer and having a haze of 55%, to form an optical film.

### Embodiment 6

A plurality of prism cylindrical microstructures (acrylic resin) with a top angle of 115° and a width of the cylindrical microstructure of 50 μm is formed on a surface of a PET support layer including an anti-scratch layer and having a haze of 55%, to form an optical film.

### Embodiment 7

A plurality of arc-shaped cylindrical microstructures (acrylic resin) with a top angle of 103°, a width of the cylindrical microstructure of 50 μm, and a top angle curvature radius of 2 μm is formed on a surface of a PET support layer including an anti-scratch layer and having a haze of 55%, to form an optical film.

### Embodiment 8

A plurality of arc-shaped cylindrical microstructures (acrylic resin) with a top angle of 103°, a width of the cylindrical microstructure of 50 μm, and a top angle curvature radius of 5 μm is formed on a surface of a PET support layer including an anti-scratch layer and having a haze of 55%, to form an optical film.

### Embodiment 9

A reflective polarizer layer is formed on a surface of a transparent PET support layer, and a plurality of transparent beads made of acrylic resin with a refractive index of 1.49 and a binder (acrylic resin) with a refractive index of 1.52 are mixed and coated onto the surface of the ¼λ film in the reflective polarizer layer, and then dried to form a 15 μm thick coating with concave-convex microstructures on the surface thereof.

### Embodiment 10

A reflective polarizer layer is formed on a surface of a transparent PET support layer, then a plurality of hemispherical micro lens structures (acrylic resin) with a diameter of 50 μm is formed on a surface of the ¼λ film in the reflective polarizer layer.

### Comparative Example 1

A commercially available optical film (Type 962, manufactured by Eternal Chemical Company) is used, and the microstructures thereof are prism cylindrical microstructures with a top angle of 90°.

Method for Measuring the Horizontal Half Brightness Angle and the Light Leakage Rate at Large Visual Angle

The optical films of Embodiments 1 to 10 and Comparative Example 1 are placed onto the double V-cut backlight module to measure the brightness. A brightness meter (SC-777, Topcon) is placed 50 centimeters right above (at an angle of 0°) the backlight source and used to measure the brightness variation at the angles of −80° and 80° inclined relative to the normal line along the horizontal direction of the backlight source with a 2° angle of the brightness meter, and then the horizontal half brightness angle and the light leakage rate at large visual angle are calculated. The horizontal half brightness angle is defined as a corresponding visual angle when the brightness is decreased to half of the brightness of the center (at an angle of 0°). The light leakage rate at large visual angle is defined as a value obtained by dividing the brightness value measured at an angle of 80° inclined from the horizontal direction of the backlight source by the brightness value of the center (at an angle of 0°), and then multiplied by 100%.

Method for Measuring the Brightness Uniformity

The optical films of Embodiments 1 to 10 and Comparative Example 1 are placed onto the double V-cut backlight module to measure the brightness uniformity. An effective light emitting area of the backlight source is equally divided into four parts, then a brightness meter (SC-777, Topcon) is placed right above (at an angle of 0°) the backlight source and used to measure the brightness values at 9 intersection points, and then the brightness uniformity is calculated. The brightness uniformity is defined as a value obtained by dividing the smallest brightness value by the largest brightness value, and then multiplying it by 100%.

Performance Test

The optical films of Embodiments 1 to 10 and Comparative Example 1 are made into backlight modules. The backlight modules corresponding to Embodiments 1 to 6 and Comparative Example 1 are shown in FIGS. 6a and 6b. The backlight modules corresponding to Embodiments 7 to 8 are shown in FIGS. 7a and 7b. The backlight module corresponding to Embodiment 9 is shown in FIGS. 9a and 9b. The backlight module corresponding to Embodiment 10 is shown in FIGS. 10a and 10b. Then, tests on various features are performed, and the test results are shown in Table 1 below.

TABLE 1

| | | | | Light |
|---|---|---|---|---|
| | | | | leakage |
| | Angle | | | rate at |
| | between the | Horizontal half | | large |
| | ridge direction | brightness | Brightness | visual |
| | and the lamp | visual angle | uniformity | angle |
| | direction (φ°) | (θ°) | (%) | (%) |
| Embodiment 1 | 45 | 75 | 71 | 36 |
| Embodiment 1 | 90 | 66 | 71 | 79 |
| Embodiment 2 | 90 | 73 | 72 | 34 |
| Embodiment 3 | 90 | 74 | 73 | 36 |
| Embodiment 4 | 90 | 108 | 79 | 64 |
| Embodiment 5 | 90 | 85 | 72 | 23 |
| Embodiment 6 | 90 | 89 | 74 | 24 |
| Embodiment 7 | 90 | 83 | 72 | 27 |
| Embodiment 8 | 90 | 86 | 76 | 24 |
| Embodiment 9 | — | 109 | 81 | 41 |
| Embodiment 10 | — | 113 | 80 | 44 |
| Comparative | 90 | 65 | 70 | 89 |
| Example 1 | | | | |

Comparison of the Horizontal Half Brightness Visual Angle

1. Comparison Between the Optical Films of Embodiments 1 to 8 and the Optical Film of Comparative Example 1:

As can be seen from Table 1, a backlight module with an optical film of Embodiments 1 to 8 with a ridge direction perpendicular to the lamp positioning direction can provide a horizontal half brightness visual angle of more than 73°. However, a backlight module with an optical film of Comparative Example 1 can only provide a horizontal half brightness visual angle of 65°. In the case that the ridge direction is perpendicular to the lamp positioning direction, by comparing the horizontal half brightness visual angles of Embodiments 2, 3 and 4, it can be known that, when the top angle and the curvature radius of the optical film are respectively set as 103° and 0 μm, if the haze of the substrate used is increased, the horizontal half brightness visual angle is enlarged accordingly. By comparing the horizontal half brightness visual angles of Embodiments 3, 5 and 6, it can be known that, when the top angle curvature radius of the optical film and the haze of the substrate are set as 0 μm and 55% respectively, the horizontal half brightness visual angle increases as the top angle increases. By comparing the horizontal half brightness visual angles of Embodiments 3, 7 and 8, it can be known that, when the top angle of the optical film and the haze of the substrate are set as 103° and 55% respectively, the horizontal half brightness visual angle increases as the top angle curvature radius increases. Compared with a double V-cut backlight module with an optical film of Comparative Example 1, the optical films of Embodiments 4, 5, 6, 7, and 8 can provide better horizontal half brightness visual angles.

2. Comparison Between the Optical Films of Embodiments 9 and 10 and the Optical Film of Comparative Example 1:

As shown in Table 1, backlight modules with an optical film of Embodiments 9 and 10 can provide a horizontal half brightness visual angle of 109° and 113° respectively. However, a backlight module with an optical film of Comparative Example 1 can only provide a horizontal half brightness visual angle of 65°. Compared with a double V-cut backlight module with an optical film of Comparative Example 1 and Embodiments 1 to 8, the optical films of Embodiments 9 and 10 can provide better horizontal half brightness visual angle.

Comparison of Brightness Uniformity

1. Comparison Between the Optical Films of Embodiments 1 to 8 and the Optical Film of Comparative Example 1:

When a double V-cut backlight module does not include any optical film, the brightness uniformity thereof is 60%. As can be seen from Table 1, a backlight module with an optical film of Embodiment 4 with the ridge direction perpendicular to the lamp positioning direction can provide a brightness uniformity of 79%. However, a backlight module with an optical film of Comparative Example 1 with the ridge direction perpendicular to the lamp can only provide a brightness uniformity of 70%. By comparing the brightness uniformities of Embodiments 2, 3, and 4, it can be known that, when the top angle and the curvature radius of the optical film are set as 103° and 0 μm respectively, the brightness uniformity increases as the haze of the substrate increases. Compared with a double V-cut backlight module with an optical film of Comparative Example 1, the optical films of Embodiments 4 and 8 can provide better brightness uniformity.

2. Comparison Between the Optical Films of Embodiments 9 and 10 and the Optical Film of Comparative Example 1:

Backlight modules with optical films of Embodiments 9 and 10 can provide brightness uniformities of 81% and 80% respectively. However, a backlight module with an optical film of Comparative Example 1 with the ridge direction being perpendicular to the lamp positioning direction can only provide a brightness uniformity of 70%. Compared with a double V-cut backlight module with an optical film of Comparative Example 1, the optical films of Embodiments 9 and 10 of the present invention can provide better brightness uniformity.

Comparison of the Light Leakage Rate at Large Visual Angle

1. Comparison Between the Optical Films of Embodiments 1 to 8 and the Optical Film of Comparative Example 1:

As shown in Table 1, a backlight module with an optical film of Embodiment 5 with the ridge direction perpendicular to the lamp positioning direction can provide a light leakage rate at large visual angle of 23%. However, a backlight module with an optical film of Comparative Example 1 with the ridge direction perpendicular to the lamp positioning direction has a high light leakage rate of up to 89% at a large visual angle. As for a backlight module with an optical film of Embodiment 1, when the angle between the ridge direction of the film and the lamp positioning direction is changed from 90° to 45°, the light leakage rate at large visual angle is reduced from 79% to 36%. In the case that the ridge direction is perpendicular to the lamp positioning direction, by comparing the light leakage rates at large visual angles of Embodiments 2, 3, and 4, it can be known that, when the top angle and the curvature radius of the optical film are set as 103° and 0 μm respectively, the light leakage rate at large visual angle has a trend of increasing as the haze of the substrate increases. By comparing the light leakage rate at large visual angle of Embodiments 3, 5, and 6, it can be known that, when the top angle curvature radius of the optical film and the haze of the substrate are set as 0 μm and 55% respectively, the light leakage rate at large visual angle decreases as the top angle of the optical film increases. By comparing the light leakage rate at large visual angle of Embodiments 3, 7, and 8, it can be known that, when the top angle of the optical film and the haze of the substrate are set as 103° and 55% respectively, the light leakage rate at large visual angle decreases as the top angle curvature radius increases.

2. Comparison Between the Optical Films of Embodiments 9 and 10 and the Optical Film of Comparative Example 1:

Backlight modules with an optical film of Embodiments 9 and 10 have the light leakage rates at large visual angle of 41% and 44% respectively, which are much lower than the light leakage rate at large visual angle of 89% of the optical film of Comparative Example 1. Compared with a double V-cut backlight module with an optical film of Comparative Example 1, the optical films of Embodiments 9 and 10 of the present invention can provide lower light leakage rate at large visual angle.

As can be seen from Table 1, the optical film of the present invention can not only increase the horizontal half brightness visual angle and the brightness uniformity, but also reduce the light leakage of the conventional condensing film at a large visual angle, and thus can be applied to the backlight module of LCD and liquid crystal TV to replace the original design.

### LIST OF REFERENCE NUMERALS

1 Display
12 Backlight module
51, 321, 421 Light guide plate
52, 122 Reflective film
53, 123 Light source
54, 94 Optical film
124 Condensing film
125 Diffuser film
321a, 421a, 421b, 511, 512 V-cut
541, 941 Support layer
542, 642 Cylindrical microstructure
542a, 642a Ridge
543 Anti-scratch layer
543a, 943a Transparent bead
543b, 943b Binder
940 Substrate
942 Reflective polarizer layer
942a Cholesterol liquid crystal layer
942b ¼λ Layer
943 Coating having concave-convex microstructures
1043 Coating having micro lens structures
L Exit Light
Lp Distance between two alleys
r Curvature radius
α Top angle degree

We claim:

1. A backlight module, comprising:
a light guide plate, having a plurality of V-cuts on both sides;
a reflective film, disposed on a lower side of the light guide plate; and
at least one light source, disposed around the light guide plate;
wherein the backlight module is characterized in comprising a single optical film disposed on an upper side of the light guide plate, and a light field of the backlight module meets the following conditions (I), (II), and (III):
horizontal half brightness visual angle≧70° (I)
brightness uniformity≧70% (II)
light leakage rate at large visual angle≦65% (III).

2. The backlight module according to claim 1, wherein the optical film comprises a substrate and a plurality of light-adjusting structures, and the light-adjusting structures are selected from a group consisting of cylindrical microstructures, conical microstructures, solid-angle microstructures, orange-peel-shaped microstructures, capsule-shaped microstructures, concave-convex microstructures, micro lens structures, and any combination thereof.

3. The backlight module according to claim 2, wherein the light-adjusting structures are cylindrical microstructures, concave-convex microstructures, or micro lens structures.

4. The backlight module according to claim 1, wherein the light source is a cold cathode fluorescent lamp.

5. The backlight module according to claim 2, wherein the light-adjusting structures are cylindrical microstructures and the cylindrical microstructures are linear cylindrical microstructures, serpentine cylindrical microstructures, zigzag cylindrical microstructures, or any combination thereof.

6. The backlight module according to claim 5, wherein the light-adjusting structures are linear cylindrical microstructures and ridges of the light-adjusting structures are non-parallel to the positioning direction of light source.

7. The backlight module according to claim 5, wherein the light-adjusting structures are linear cylindrical microstructures and ridges of the light-adjusting structures are perpendicular to the positioning direction of light source.

8. The backlight module according to claim 5, wherein a top angle of the cylindrical microstructures is about 95°-130°, and a top angle curvature radius of the cylindrical microstructures is less than about 10 μm.

9. The backlight module according to claim 8, wherein the top angle of the cylindrical microstructures is about 100°-120°, and the top angle curvature radius of the cylindrical microstructures is less than about 5 μm.

10. The backlight module according to claim 5, wherein the cylindrical microstructures are coatings formed by applying a plurality of microstructures to a surface of the substrate.

11. The backlight module according to claim 10, wherein the coating comprises ultraviolet (UV) cured acrylic resin, and the acrylic resin is selected from a group consisting of (meth)acrylate resin, urethane acrylate resin, polyester acrylate resin, epoxy acrylate resin, and any mixture thereof.

12. The backlight module according to claim 2, wherein the optical film further comprises an anti-scratch layer formed by embossing or coating.

13. The backlight module according to claim 1, wherein the optical film has a haze of about 20%-95% as measured according to HS K7136 standard.

14. The backlight module according to claim 1, wherein a valley line of the V-cut extends as a straight line, and the valley lines of the V-cuts on the same side of the light guide plate are parallel to each other, while the valley lines of the V-cuts on different sides of the light guide plate are non-parallel to each other.

15. The backlight module according to claim 2, wherein the substrate comprises a support layer.

16. The backlight module according to claim 15, wherein the substrate further comprises a reflective polarizer layer.

17. A backlight module, comprising:
a light guide plate, having a plurality of V-cuts on both sides;
a reflective film, disposed on a lower side of the light guide plate; and
at least one light source, disposed around the light guide plate;
wherein the backlight module is characterized in comprising a single optical film disposed on an upper side of the light guide plate, and the optical film comprises a substrate and a plurality of micro lens structures, and the substrate comprises a support layer and a reflective polarizer layer, and a light field of the backlight module meets the following conditions (I), (II), and (III):
horizontal half brightness visual angle≧70° (I)
brightness uniformity≧70% (II)
light leakage rate at large visual angle≦65% (III).

18. A backlight module, comprising:
a light guide plate, having a plurality of V-cuts on both sides;
a reflective film, disposed on a lower side of the light guide plate; and
at least one light source, disposed around the light guide plate;
wherein the backlight module is characterized in comprising a single optical film disposed on an upper side of the light guide plate, and the optical film comprises a support layer, a plurality of linear arc-shaped cylindrical structures, and an anti-scratch layer, wherein a top angle of the cylindrical microstructures is about 100°-120°, a top angle curvature radius of the cylindrical microstructures is less than about 5 μm, and a ridge of the light-adjusting structures is perpendicular to the positioning direction of light source,
the optical film has a haze of about 20%-95% as measured according to JIS K7136 standard, and a light field of the backlight module meets the following conditions (I), (II), and (III):
horizontal half brightness visual angle≧70° (I)
brightness uniformity≧70% (II)
light leakage rate at large visual angle≦65% (III).
